(19) United States
(12) Patent Application Publication
(10) Pub. No.: US 2025/0329027 A1
(43) Pub. Date: Oct. 23, 2025

(54) ELECTRONIC DEVICE AND METHOD WITH IMAGE SEGMENTATION

(71) Applicant: Samsung Electronics Co., Ltd., Suwon-si (KR)

(72) Inventors: Yujia ZHANG, Xi'an (CN); Sanqi LI, Xi'an (CN); Seungin PARK, Suwon-si (KR); Ying MIN, Xi'an (CN); Byung In YOO, Suwon-si (KR); Ju Hwan SONG, Suwon-si (KR); Yunhao ZHANG, Xi'an (CN); Feng ZHU, Xi'an (CN)

(73) Assignee: Samsung Electronics Co., Ltd., Suwon-si (KR)

(21) Appl. No.: 19/063,181

(22) Filed: Feb. 25, 2025

(30) Foreign Application Priority Data
Apr. 22, 2024 (CN) 202410483677.9
Oct. 21, 2024 (KR) 10-2024-0143756

(51) Int. Cl. G06T 7/143; G06T 7/174; G06T 7/73

(52) U.S. Cl. CPC G06T 7/143; G06T 7/174; G06T 7/74; G06T 2207/20076; G06T 2207/20081; G06T 2207/20084

(57) ABSTRACT

A method of operating an electronic device includes: inputting a multi-frame image to a first image segmentation model that infers therefrom preliminary segmentation probability maps of the respective frames included in the multi-frame image; forming the preliminary segmentation probability maps into respective final segmentation probability maps by aligning the preliminary segmentation probability maps into a same three-dimensional space according to differences in poses of the respective frames, each pose including an angle and position of its corresponding frame; and obtaining a final image segmentation result for the multi-frame image based on inputting the obtained final segmentation probability maps to a second image segmentation model.

### CROSS-REFERENCE TO RELATED APPLICATIONS

This application claims the benefit under 35 USC § 119 (a) of Chinese Patent Application No. 202410483677.9, filed on Apr. 22, 2024, in the China National Intellectual Property Administration, and Korean Patent Application No. 10-2024-0143756, filed on Oct. 21, 2024, in the Korean Intellectual Property Office, the entire disclosures of which are incorporated herein by reference for all purposes.

### BACKGROUND

### 1. Field

The following description relates to the field of computer vision technology, and more particularly, to an electronic device and method with image segmentation.

### 2. Description of Related Art

As autonomous driving technology develops, the integrity of autonomous driving systems is emerging as a critical issue in terms of reliability. An autonomous driving system generally has three core modules; a detection module, a decision planning module, and a control execution module. The detection module collects and processes information about the surrounding environment of a vehicle, and the accuracy of this detection module affects the decision planning module and the control execution module, and therefore plays a key role in determining driving safety of the vehicle. Particularly, bird's-eye view (BEV) detection from an overhead perspective of the vehicle may play a useful role in accurately recognizing the surrounding environment of the vehicle.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an electronic device includes: one or more processors; and a memory storing instructions configured to cause the one or more processors to perform a process including: inputting a multi-frame image comprising frames to a first image segmentation model that generates preliminary segmentation probability maps based on the multi-frame image; obtaining final segmentation probability maps by aligning the preliminary segmentation probability maps into a same space according to pose deltas of the frames, each pose delta including a position change and an angle change; and obtaining a final image segmentation result by inputting the obtained final segmentation probability maps to a second image segmentation model.

One of the frames may be a reference frame and the other frames may be non-reference frames, and the process may further include: determining the pose deltas relative to a pose of the reference frame; aligning the preliminary segmentation probability maps of the respective non-reference frames into a same space as the preliminary segmentation probability map of the reference frame, based on the determined pose deltas; setting pixel values for an empty space in the preliminary segmentation probability maps of the non-reference frames, the empty space caused by the aligning of the preliminary segmentation probability maps and lacking pixel values derived from the first image segmentation model; and obtaining the final segmentation probability maps by connecting the preliminary segmentation probability maps having the set pixel values.

The determining of the pose deltas includes: obtaining positions and angles of a same object included in each of the reference frame and the non-reference frames; and determining the pose deltas of the non-reference frames by comparing the position and angle of the object in the reference frame with the positions and angles of the object in the non-reference frames.

The setting of the pixel values for the empty space may include, for a pixel in the empty space, in response to a number of valid pixels surrounding the pixel being greater than a preset number, determining a pixel value of the pixel based on pixel values of the valid pixels.

The setting of the pixels in the empty space includes, for a pixel in the empty space, in response a number of valid pixels surrounding the pixel being less than a preset number, determining a pixel value of the pixel based on a pixel value of a valid pixel, of the reference frame, that spatially corresponds to the pixel.

The setting of the pixel value for the empty space may include determining the pixel value of the omitted pixel by performing a matrix operation using a transformation matrix on the pixel value of the valid pixel of the reference frame.

The obtaining of the final image segmentation result may include: extracting a semantic feature by fusing the final segmentation probability maps; and obtaining the final image segmentation result by decoding the extracted semantic feature and determining a final category for each pixel of the final segmentation probability maps.

The multi-frame image may be generated from frames selected at set intervals from among frames collected over a predetermined period of time.

In another general aspect, a method of operating an electronic device includes: inputting a multi-frame image to a first image segmentation model that infers therefrom preliminary segmentation probability maps of the respective frames included in the multi-frame image; forming the preliminary segmentation probability maps into respective final segmentation probability maps by aligning the preliminary segmentation probability maps into a same three-dimensional space according to differences in poses of the respective frames, each pose including an angle and position of its corresponding frame; and obtaining a final image segmentation result for the multi-frame image based on inputting the obtained final segmentation probability maps to a second image segmentation model.

The obtaining of the final segmentation probability map may include: determining displacement and rotation differences between a reference frame, among the frames, and the other of the frames, which are non-reference frames; aligning the preliminary segmentation probability maps of the non-reference frames into a space of the preliminary segmentation probability map of the reference frame, based on the determined displacements and rotations; and before obtaining the final segmentation probability map, setting a pixel value for an empty space in a preliminary segmentation probability map of a non-reference frame, the empty space formed by the aligning of the preliminary segmentation probability map of the non-reference frame into the space of the preliminary segmentation probability map of the reference frame.

The determining of the displacements and the rotations may include: obtaining positions and angles of an object included in each of the reference frame and the non-reference frames; and determining the displacements and the rotations based on the obtained positions and the obtained rotation angles of the object.

The setting of the pixel value for the empty space may include, for a pixel in the empty space that does not have a value derived from the first image segmentation model due to the aligning of the preliminary segmentation probability containing the empty space, based on a number of valid pixels neighboring the pixel being greater than a threshold, setting the pixel to a value that is based on the pixel values of the valid pixels.

The setting of the pixel value for the empty space may include, for a pixel in the empty space that does not have a value derived from the first image segmentation model due to the aligning of the preliminary segmentation probability containing the empty space, based on a number of valid pixels neighboring the pixel being less than a threshold, setting the pixel to a value that is based on the pixel value of a pixel of the reference frame that spatially corresponds to the pixel in the empty space.

The setting of the pixel value for the empty space may include determining the pixel value of the pixel of the empty space by performing a matrix operation using a transformation matrix on the pixel of the reference frame.

The obtaining of the final image segmentation result may include: extracting a semantic feature by fusing the final segmentation probability maps; and obtaining the final image segmentation result by decoding the extracted semantic feature and determining a final category for each pixel of the final segmentation probability maps.

The multi-frame image may be generated from the frames, which are selected at set intervals from among frames collected over a predetermined period of time.

A non-transitory computer-readable storage medium stores instructions that, when executed by a processor, cause the processor to perform any of the methods.

In another general aspect, a method performed by a computing device includes: capturing images from respective image sensors, and inputting the images to a first image segmentation model that infers birds-eye-view (BEV) image segmentation probability (ISP) maps of the respective images, the images including a reference image and non-reference images, the reference image corresponding to a reference BEV ISP map among the BEV ISP maps, the non-reference images respectively corresponding to non-reference BEV ISP maps among the BEV ISP maps, and the images having associated therewith different three-dimensional poses, respectively; performing, according to the poses, rotational and translational transforms on the BEV ISP maps to put the BEV ISP maps in a same alignment with respect to each other, the performing creating regions in the BEV ISP maps that lack data derived from the first image segmentation model; for first pixels in the regions that have a number of neighboring pixels in the same non-reference BEV ISP map above a threshold, setting the first pixels to values of their neighboring pixels in the same non-reference BEV ISP map, and for second pixels in the regions that do not have a number of neighboring pixels in the same non-reference BEV ISP map above the threshold, setting the second pixels to values of corresponding pixels the reference BEV ISP map; and after the setting of the first and second pixels, generating a final BEV ISP map by inputting the BEV ISP maps to a second image segmentation model that infers there from the final BEV ISP map.

Other features and aspects will be apparent from the following detailed description, the drawings, and the claims.

### BRIEF DESCRIPTION OF THE DRAWINGS

FIG. 1 illustrates an example of an electronic device for performing image segmentation, according to one or more embodiments.

FIG. 2 illustrates an example of an operation method of an electronic device, according to one or more embodiments.

FIG. 3 illustrates an example of image segmentation, according to one or more embodiments.

FIG. 4 illustrates an example of a result of performing multi-frame spatial alignment (MSA) and time-series information complementation, according to one or more embodiments.

FIG. 5 illustrates an example of a spatial alignment method applied to a preliminary segmentation probability map, according to one or more embodiments.

FIG. 6 illustrates an example of a method of supplementing an empty space generated during a spatial alignment process for a preliminary segmentation probability map, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

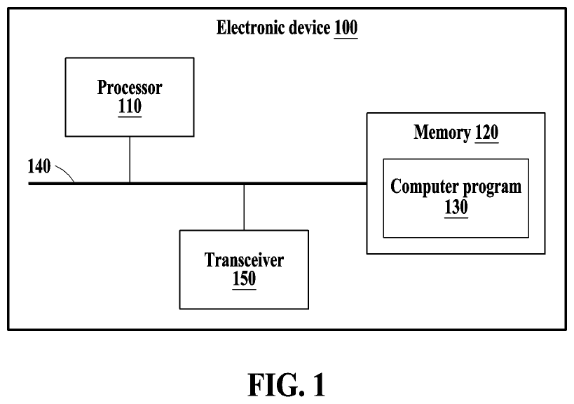

FIG. 1 illustrates an example of an electronic device for performing image segmentation, according to one or more embodiments.

Bird's-eye view (BEV) semantic segmentation technology may provide road/surroundings information by analyzing an environment around a vehicle from a top-down perspective in an autonomous driving system. This BEV semantic segmentation technology may operate in an offline mode/configuration and an online mode/configuration.

In the offline mode, the BEV semantic segmentation technology may be mainly used for data labeling and model training. More specifically, in the offline mode, the BEV semantic segmentation technology may detect the environment around the vehicle by analyzing data collected through vehicle-mounted sensor(s). In the offline mode, the BEV semantic segmentation technology may analyze data collected during an entire span of driving to detect the environment around the vehicle, and thus, a more accurate BEV semantic segmentation result may be obtained. Here, offline mode refers to an environment where data is collected in advance and analyzed later rather than in real-time.

In the online mode, the BEV semantic segmentation technology may be mainly installed in the vehicle to be used to analyze data collected through the vehicle-mounted sensor(s), in real time. To this end, in the online mode, the BEV semantic segmentation technology may use a BEV semantic segmentation model that has been trained in the offline mode.

Previously, commonly used vehicle-mounted sensors may include cameras with different fields of view for obtaining image data, roof-mounted light detection and ranging (LIDAR) for obtaining point cloud data, multi-field of view millimeter wave radio detection and ranging (radar), a global positioning system (GPS), and/or an inertial measurement unit (IMU). However, the types of vehicle-mounted sensors are only an example and not limited to the above examples.

When the data collected through such vehicle-mounted sensors is input into a BEV semantic segmentation model, predicted road information about the environment surrounding the vehicle may be obtained from the BEV semantic segmentation model.

However, a BEV semantic segmentation model for predicting road information about environment surrounding a vehicle may be large in scale and complex in structure, and its segmentation results accuracy may be low, so the BEV semantic segmentation model may not be practical to use directly. While post-processing of segmentation results is possible, all post-processing optimization methods for BEV semantic segmentation results generally require manual auxiliary modification, and there is no easy post-processing optimization method to improve the accuracy of the BEV semantic segmentation results.

Accurate prediction of road information may be a highly beneficial step in autonomous driving technology, and reliability and real-time performance should be as high as possible for safe driving, among other things. However, BEV semantic segmentation results obtained by current methods may have low accuracy and prominent rapid changes in information between adjacent frames. Accordingly, it may be difficult to provide reliable information for subsequent decision making in the online mode, and manual correction may be required in the offline mode to obtain data suitable for data labeling and model training.

Various embodiments an examples of an electronic device described herein may of improve the accuracy and continuity of BEV semantic segmentation results with less human resource and time.

Referring to FIG. 1, an electronic device 100 may include at least one processor 110 and a memory 120 for loading or storing a computer program 130 executed by the processor 110. The processor 110 and the memory 120 may be connected to each other via a communication link 140 (e.g., a bus). Optionally, the electronic device 100 may further include a transceiver 150 (e.g., a network interface card or the like), and the transceiver 150 may be used for data exchange, such as transmission and/or reception of data between the electronic device 100 and another electronic device. The components included in the electronic device 100 of FIG. 1 are just an example and other components may be further included.

The processor 110 may control the overall operation of each component of the electronic device 100. The processor 110 may include at a central processing unit (CPU), a microprocessor unit (MPU), a microcontroller unit (MCU), a graphics processing unit (GPU), a neural processing unit (NPU), a digital signal processor (DSP), and/or other types of processors in a relevant technical field. In addition, the processor 110 may perform an operation on the computer program 130 (instructions/code) or at least one application to execute a method and/or an operation according to various examples described herein. The electronic device 100 may include one or more processors.

The memory 120 may store one or a combination of two or more of various pieces of data, commands, or information used by a component (e.g., the processor 110) included in the electronic device 100. The memory 120 may include volatile memory and/or non-volatile memory (but not a signal per se).

The computer program 130 may include instructions/code that, when executed, implement the methods/operations described herein; the computer program 130 may be stored in the memory 120. The program 130 may include instructions that when executed perform (i) receiving preliminary segmentation probability maps for respective frames in a multi-frame image (the preliminary segmentation probability maps being obtained in response to inputting the multi-frame image to a first image segmentation model), (ii) obtaining final segmentation probability maps of the respective frames in the multi-frame image by aligning the preliminary segmentation probability maps of the frames into a same space/alignment to reflect a position change and an angle change that occurs between each of the frames, and (iii) obtaining final image segmentation results for the respective frames in the multi-frame image, in response to inputting the obtained final segmentation probability maps to a second image segmentation model.

When the computer program 130 is loaded to the memory 120, the processor 110 may execute various methods and/or operations according to various examples of the present disclosure by executing operations to implement the program 130.

The communication link 140 may include a path to transmit various pieces of data, commands, and information among components included in the electronic device 100. The communication link 140 may be, for example, a peripheral component interconnect (PCI) bus or an extended industry standard architecture (EISA) bus. However, the type of the bus is an example and not limited thereto. For example, a bus is illustrated by a single line for ease of description in FIG. 1, but various types of buses may be included.

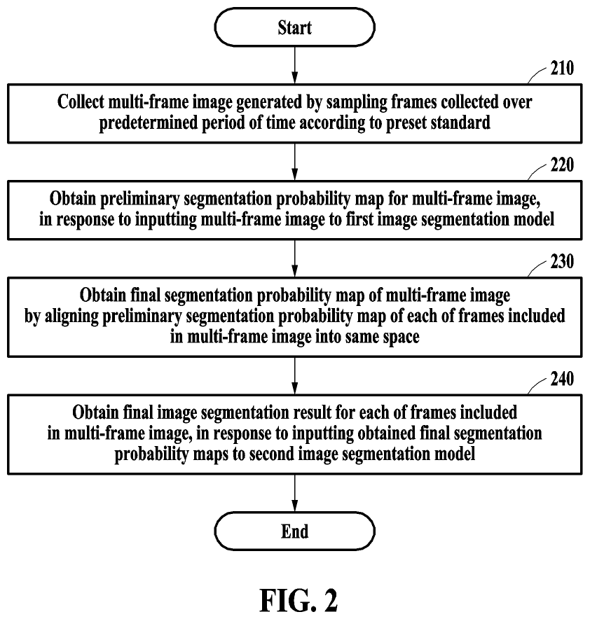

FIG. 2 illustrates an example of an operation method of an electronic device, according to one or more embodiments. The operations shown in FIG. 2 may be performed by at least one component of an electronic device (e.g., the electronic device 100 of FIG. 1).

In operation 210, a processor (e.g., the processor 110 of FIG. 1) of an electronic device may collect a multi-frame image generated, for example, by sampling frames collected over a predetermined period of time according to a preset standard. The multi-frame image may contain image data of actual road conditions and/or vehicle driving state collected from an autonomous driving system. However, the type of the frame is only an example and not limited to the above example.

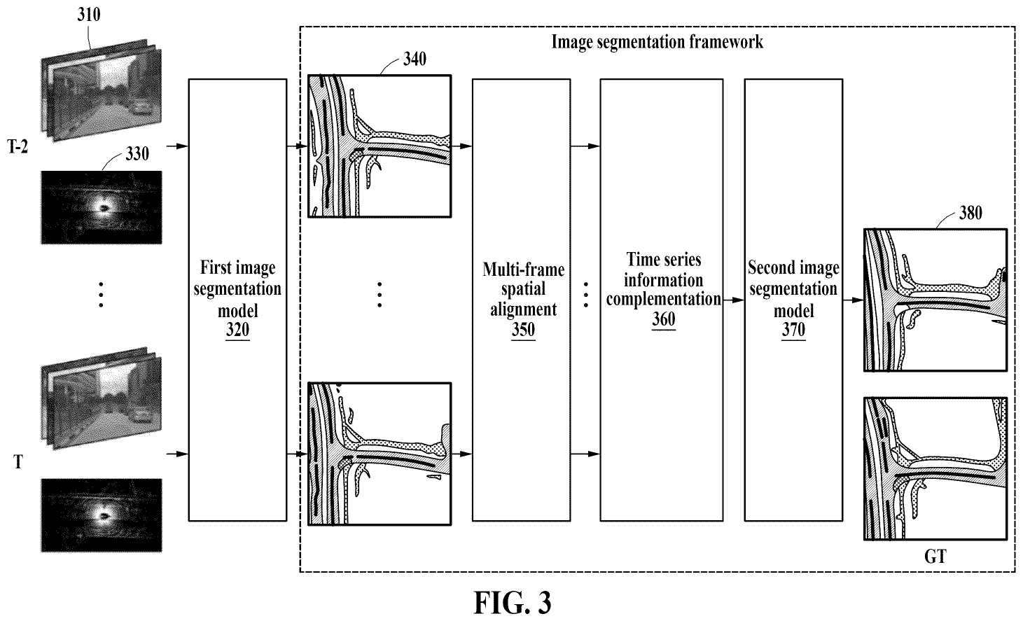

The processor may select one multi-view red, green, and blue (RGB) frame 310 at a set interval (e.g., every 20 frames) from among multi-view RGB image frames collected over a predetermined period of time using a vehicle-mounted sensor, as shown in FIG. 3, and may generate a multi-frame image by grouping selected multi-view RGB frames (RGB images of different views/sensors). However, such a sampling method of generating the multi-frame image is only an example and not limited to the above example. Note that the frames T are all from the same camera, taken at different times.

In operation 220, the processor may obtain a preliminary segmentation probability map for the multi-frame image, in response to inputting the multi-frame image to a first image segmentation model. Here, the first image segmentation model may be an artificial intelligence model based on deep learning (e.g., a neural network) that classifies pixels of each frame included in the multi-frame image into specific categories. For example, the first image segmentation model may be a BEV semantic segmentation model 320 as shown in FIG. 3. However, this type of the first image segmentation model is only an example, and when the preliminary segmentation probability map may also be obtained using various other networks (as the first image segmentation model) such as a convolutional neural network and an attention network.

According to an example, the first image segmentation model may perform image segmentation on each of the frames included in the multi-frame image to generate the preliminary segmentation probability maps respectively corresponding to the frames. Each preliminary segmentation probability map may include, for each pixel of the corresponding frame, a category probability value indicating which category the corresponding pixel is likely to belong to. Here, in a preliminary segmentation probability map, category probability values for the respective pixels (e.g., “N”) of the corresponding frame may be determined. For example, the preliminary segmentation probability map may be represented, for a particular pixel, as a probability value for a category of possible types that may exist in an environment around a vehicle for that pixel, such as a probability value for a category in which the corresponding pixel is a pedestrian, a probability value for a category in which the pixel is a vehicle, a probability value for a category in which the pixel is a road, and a probability value for a category in which the pixel is a tree.

According to an example, input of the first image segmentation model may include, in addition to the multi-frame image, point cloud data 330, a position of a vehicle, an angle of a vehicle, a timestamp, and/or a transformation matrix between coordinate systems. The point cloud data 330 may be three dimensional (3D) spatial information collected through a LIDAR sensor, the position of the vehicle may represent a current position of the vehicle measured through a GPS sensor and/or an inertial navigation system (INS), the angle of the vehicle may represent a direction the vehicle is facing measured through an IMU sensor or a gyroscope sensor, the timestamp may represent the time at which each frame is collected, and the transformation matrix between coordinate systems may be a transformation matrix used to match a local coordinate system of the vehicle to a coordinate system of sensor data.

The processor may select one category for each pixel by binarizing/discretizing the preliminary segmentation probability map for the multi-frame image generated through the first image segmentation model using a threshold value selected according to a preset standard. For example, for a particular pixel in the preliminary segmentation probability map, when the probability value of the pixel being a pedestrian category is 0.7 and the probability value of the bring a tree category is 0.3, when a threshold value of 0.5 is applied, a corresponding feature pixel may be selected as a pedestrian category through binarization processing. Accordingly, the processor may overlap information about the category selected for each pixel to finally obtain a preliminary segmentation probability map/volume (H*W*N) 340 for each frame of the multi-frame image, as shown in FIG. 3. Here, H represents the height of the frame input to the first image segmentation model, W represents the width of the frame, and N represents the total number of categories.

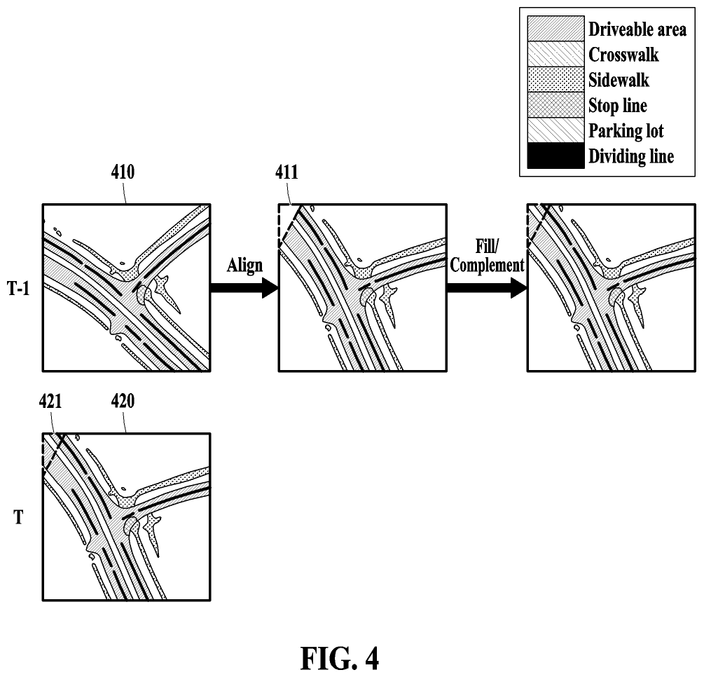

In operation 230, the processor may obtain a final segmentation probability map of the multi-frame image by aligning the preliminary segmentation probability maps of the corresponding frames into a same space/alignment by reflecting a position change and an angle change (e.g., due to movement of the vehicle) that occur in each of the frames included in the multi-frame image. In an autonomous driving system, when a vehicle is driving, the field of view that may be collected through a single camera is limited and a viewpoint of the camera constantly changes due to movement of the vehicle, and thus, relative to the camera, positions and angles of an object in the vehicle's environment may change for each frame. For example, as shown in FIG. 4, where T and T−1 are indices of respective frames in the multi-frame image, a road that has been segmented in a T−1-th frame 410 may actually be in the same physical location when segmented in a T-th frame 420 but may appear in a different location in the corresponding preliminary segmentation probability map due to a change in the viewpoint of a camera. Accordingly, when the segmentation probability map of the T−1-th frame 410 directly overlaps the segmentation probability map of the T-th frame 420, incorrect matching may occur, increasing error information. To address these limitations, the processor may perform a process of multi-frame spatial alignment 350 that matches and aligns the frames included in the multi-frame image to the same coordinate system, as shown in FIG. 3.

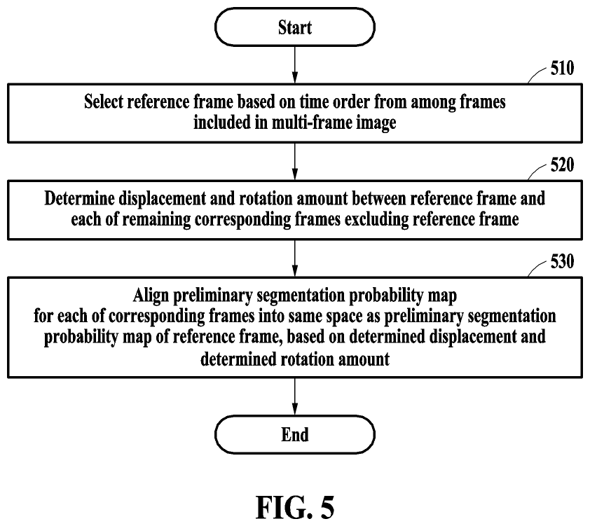

Referring to FIG. 5, a method of aligning the preliminary segmentation probability map of the frames included in the multi-frame image to the same space is described. In operation 510, the processor may select a reference frame from among the frames based on a time order of the frames. As a non-limiting example, the processor may select, as the reference frame, the chronologically last frame

In operation 520, the processor may determine inter-frame pose deltas (each being a displacement delta and rotation delta) between the reference frame and the respective non-reference frames. To do so, the processor may obtain position information (positions) and rotation angle information (rotations/angles) of an object included in the reference frame and each of the non-reference frames. Also for the purpose of finding the inter-frame pose deltas, the processor may obtain a pose of the vehicle, which includes location information of the vehicle (e.g., collected through a GPS sensor, a LIDAR sensor, and/or an odometer) and includes an orientation (rotation angle information) of the vehicle using information collected through an inertial measurement unit sensor, a gyroscope sensor, or the like.

The processor may determine the pose deltas between the reference frame and the respective non-reference frames, based on the object poses of the object obtained in the respective frames. Each pose delta is a value representing how much the object has moved between two corresponding frames. The processor may determine the deltas between the reference frame and the a non-reference frame by subtracting object position information of the non-reference frames from object position information of the reference frame. Considering that the rotation amount is a value representing how much the object has rotated between two frames, the processor may determine the rotation amounts (rotation deltas) between the reference frame and the non-reference frames by subtracting object rotation angle information of the non-reference frames from object rotation angle information of the reference frame. As described, the processor may determine the pose deltas (displacements and the rotation amounts) between the reference frame and the non-reference frames.

In operation 530, the processor may align the preliminary segmentation probability maps of the respectively corresponding frames into the same space as the preliminary segmentation probability map of the reference frame, based on the determined pose deltas (displacements and rotation amounts) of the respective non-reference frames. More specifically, the processor may transform, based on the pose deltas, the preliminary segmentation probability maps of the respective non-reference frames into the same coordinate system as that of the reference frame by using matrix transformations. For example, the processor may use similarity transformations, which is a type of affine transformation, to the preliminary segmentation probability maps of the non-reference frames to transform them into the same coordinate system as that of the preliminary segmentation probability map of the reference frame.

However, when the matrix transformations are applied to the preliminary segmentation probability maps of the non-reference frames (thus aligning them into the same space as the preliminary segmentation probability map of the reference frame), floating point positions may occur that are not processed by movement transformation and rotation transformation, and thus, some pixels may not correspond, resulting in an empty space in any of the aligned preliminary segmentation probability maps. To address this issue, the processor may additionally perform a task of time series information complementation 360, as shown in FIG. 3, to complement (fill/set) any empty space(s) generated during the spatial alignment process. Note that empty space is an area in the preliminary segmentation probability map of the “non-reference frame” where pixel values are not derived by the first segmentation model when aligning the preliminary segmentation probability map of the non-reference frame to the same space as that of the reference frame.

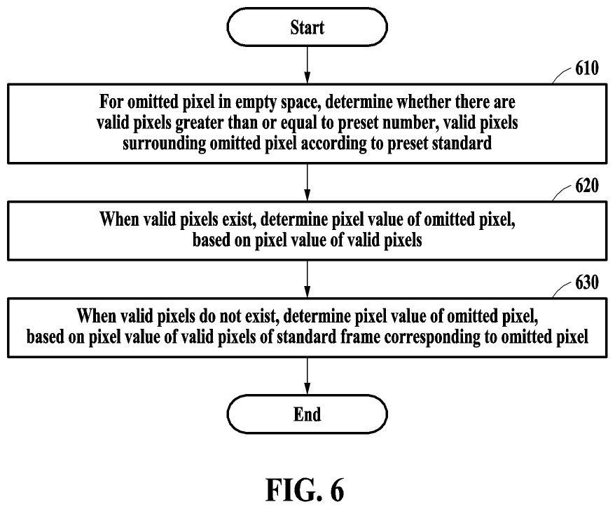

Referring to FIG. 6, a method of complementing an empty space generated in the spatial alignment process of the preliminary segmentation probability maps is described (“complementing” refers to determining values for pixels in the empty space). In operation 610, for an omitted pixel (a pixel in the empty space) in a given preliminary segmentation probability map, the processor may determine whether there is a sufficient number of valid pixels (i.e., a number greater than or equal to a preset number) surrounding the omitted pixel (the omitted pixel is described in the next paragraph), and that determination may be made according to a method of interpolation being used to complement the omitted pixel (a valid pixel is a pixel that is not in an empty space, i.e., is actual data derived from the frames). For example, when bilinear interpolation is used to complement the pixel value of the omitted pixel, there may need to be “4” valid pixel values surrounding the omitted pixel. When trilinear interpolation is used, there may need to be “8” valid pixel values surrounding the omitted pixel. Surrounding pixels may be pixels in preliminary segmentation probability maps (other than the given one containing the omitted pixel), where a pixel is “surrounding” or a neighbor according to its location being near a same coordinate as the coordinate of the omitted pixel. Of course, the same process may be performed for all omitted pixels in any of the preliminary segmentation probability maps (other than that of the reference frame, which has not been transformed by the alignment process).

An omitted pixel can be compensated in different ways depending on the number of valid pixels located in the “surrounding” area within the same preliminary segmentation probability map. For example, if the number of valid pixels located in the surrounding area of the omitted pixel within the same preliminary segmentation probability map is equal to or greater than a predetermined number (e.g., 4), the pixel value of the omitted pixel can be compensated using linear interpolation based on those valid pixels. On the other hand, if the number of valid pixels located in the “surrounding” area of the omitted pixel within the same preliminary segmentation probability map is less than the predetermined number (e.g., 4), the pixel value of the omitted pixel can be compensated by replacing it with the corresponding valid pixel value from the preliminary segmentation probability map of the reference frame.

In operation 620, when the number of valid surrounding pixels is greater than or equal to the preset number, the processor may determine the pixel value of the omitted pixel, based on the pixel values of the surrounding valid pixels. For example, when bilinear interpolation is used to complement/compute the pixel value of the omitted pixel, the processor may determine the pixel value for the omitted pixel by calculating a weighted average of the pixel values of the “4” valid surrounding pixels.

In operation 630, when the number of surrounding valid pixels is not greater than or equal to the preset number, the processor may determine/compute the pixel value of the omitted pixels based on pixel values of valid pixels of the preliminary segmentation probability map of the reference frame, and specifically, pixels thereof that spatially corresponding to the omitted pixels (the reference frame has not been subjected to alignment and therefore does not have omitted pixels). For example, referring to FIG. 4, there may be a blank area 411 in which the valid pixels surrounding the omitted pixel do not exist, such as in the result of the multi-frame spatial alignment (MSA) of the T−1-th frame 410.

In this case, the processor may identify a pixel value 421 for the valid pixel corresponding to the blank area 411 of the T−1-th frame 410 in the T-th frame 420, which is the reference frame. Accordingly, the processor may complement/fill the pixel value for the blank area 411 of the T−1-th frame 410, based on the identified pixel value 421 of the T-th frame 420. For example, the processor may complement the pixel value for the blank area 411 of the T−1-th frame 410 by performing a matrix operation using the T−1-th frame's transformation matrix on the pixel value 421 of the T-th frame 420. The non-omitted pixels of the T−1-th frame 410 are maintained as they are. The processor may perform the aforementioned spatial alignment and omitted pixel complementation for each frame of the multi-frame image currently being processed.

Returning to FIG. 2, the processor may obtain the final segmentation probability map/volume (H*W*(N*num_t)) for the multi-frame image by combining (e.g., concatenating) the preliminary segmentation probability maps of the respective frames of the multi-frame image, which have been subjected to the spatial alignment and the omitted pixel complementation, and this may be done for each channel. Here, H represents the height of the frames, W represents the width of the frames, N represents the number of categories, and num_t represents the number of frames included in the multi-frame image.

In operation 240, the processor may obtain a final image segmentation result for the multi-frame image, in response to inputting the obtained final segmentation probability maps to a second image segmentation model. For example, as shown in FIG. 3, a second image segmentation model 370 may be implemented as a deep learning-based network (e.g., a neural network) that fuses final segmentation probability maps obtained from the multi-frame image and uses the fusion result to output a final image segmentation result 380 for the multi-frame image. Note that the final segmentation probability maps may be the classification results of each pixel in a frame as a specific object. The second image segmentation result provides the classification result of each pixel in a frame based on the fusion of the final segmentation probability maps. Accordingly, a final map exists for each frame of the multi-frame images.

According to an example, the second image segmentation model may include at least one of an input layer, a feature extraction module/layer(s), a feature decoding module/layer(s), and an output layer. The input layer may receive the final segmentation probability maps generated from the multi-frame image. The feature extraction module may output high-dimensional semantic features in which spatiotemporal information between the frames is reflected, by receiving and fusing the final segmentation probability maps from the input layer. The feature decoding module may receive the high-dimensional semantic features as input from the feature extraction module and may decode the high-dimensional semantic features, thereby calculating the category probability for each pixel of the final segmentation probability map. The output layer may output the final image segmentation result for each of the frames included in the multi-frame image by determining, based on the calculated category probability, a category with the highest probability as the final category of a corresponding pixel.

A loss function loss(x, y) of the second image segmentation model may be expressed as Equation 1 below.

$$loss ( x , y ) = - {\sum }_{i} y [ i ] * log ( {( 1 + exp ( - x [ i ] ) )}^{- 1} ) + ( 1 - y [ i ] ) * log ( \frac{exp ( - x [ i ] )}{( 1 + exp ( - x [ i ] ) )} ) \qquad Equation 1$$

Here, [symbol] represents a predicted category value of the second image segmentation model for a particular pixel, and [symbol] represents an actual category value for the particular pixel. i ranges from 1 to N, where N is an output dimension of the second image segmentation model.

The second image segmentation model may be trained by (i) calculating an error between a predicted category value and an actual category value (e.g., ground truth (GT) of FIG. 3), and based on the error, updating the model (e.g., adjusting weights) to minimize the calculated error.

An image segmentation framework as described herein may support a second image segmentation model suitable for various image segmentation tasks in various application fields. More specifically, the image segmentation framework may have high portability and generalizability in that the range of applicable application fields may be expanded by simply modifying the input layer and the output layer of the second image segmentation model.

For example, the second image segmentation model may be an image segmentation model such as a TransUNet model, which is used in the field of medical image segmentation, a specialized multilayer perceptron (S-MLP) model used for image classification and image segmentation tasks based on LiDAR, or a GTUNet model used for medical image segmentation tasks such as X-rays. These types of image segmentation models are discussed next, however, the second image segmentation model may be implemented with other types of models

The TransUNet model combines a transformer and a UNet and may provide the advantages of both extracting global information and refining local detail information. When the image segmentation method described herein is performed using the TransUNet model, the processor may adjust an input dimension and an output dimension of the TransUNet model.

Usually, an image is in a three-channel RGB format, but this may not match the number of “N” categories to be obtained through the image segmentation framework, and thus, the processor may adjust the input dimension of the first layer of the TransUNet model to N*num_t and may also change the output dimension of the last layer to N, so as to obtain an optimized image segmentation result for the “N” categories.

In addition, the processor may change the loss function of the TransUNet model. According to an example, the BEV semantic segmentation technology may be performed as a multi-label task. For example, since an environment position may be both a drivable area and a divider, the processor may change the loss function to a multi-label loss function and may use the multi-label loss function. For example, the processor may change the loss function to Equation 1 above, as a non-limiting example.

In addition, the processor may optimize the structure of the TransUNet model. Since the image segmentation framework aims at optimization after the BEV semantic segmentation, some repetitive modules may be eliminated when operations are performed within the same modality. In an existing TransUNet model, a 12-layer ViT Block, a type of transformer model, may be used to calculate global attention, which is difficult to obtain using a convolution operation, and global information may be complemented through the calculated global attention. By reducing the number of such repetitive layers of the ViT Block, the processor may efficiently optimize the image segmentation result, and at the same time, may greatly reduce the amount of parameters of the TransUNet model.

The S-MLP model is a model used for LiDAR-based image classification and image segmentation tasks, and may be formed by fully connected layers that essentially share parameters. Such a structure may reduce the number of parameters due to the structure similar to a one-dimensional convolution, thereby increasing portability of the model.

When the image segmentation method is performed using the S-MLP model, the processor may use a method of (i) expanding a category space of dimension N to 1024 feature dimensions using six fully connected layers and then (ii) reducing the 1024 dimensions back to the N-dimension category space. As described above, the BEV semantic segmentation technology may be performed as the multi-label task, so the processor may use the loss function by changing the loss function to the multi-label loss function. For example, the processor may change the loss function to Equation 1 above, but the form of this loss function is only an example and not limited to the above example. Further regarding the number of categories N, the second image segmentation model (e.g., TransUNet model, S-MLP model, GTUNet model) can classify each pixel of a frame into one of N categories. That is, N represents the number of categories that the second image segmentation model can classify.

The GTUNet model is a model frequently used for performing image segmentation tasks on medical images such as X-rays, and may include a transformer structure to which an attention mechanism is applied. When the image segmentation method described herein is performed using the GTUNet model, the processor may adjust the input dimension and the output dimension of the GTUNet model as needed.

Usually, an image uses a three-channel RGB format, but this may not match the number of “N” categories to be obtained through the image segmentation framework, and thus, the processor may adjust the input dimension of the first layer of the GTUNet model to N*num_t and may also change the output dimension of the last layer to N, so as to obtain an optimized image segmentation result for the “N” categories.

In addition, the processor may change the loss function of the GTUNet model to the multi-label loss function and may use the multi-label loss function. According to an example, the BEV semantic segmentation technology may be performed as the multi-label task since a position in the environment may be both a drivable area and a divider. For example, the processor may change the loss function to Equation 1 above, as a non-limiting example.

Accordingly, the image segmentation framework described herein may input the preliminary segmentation probability map of an arbitrary semantic segmentation model, may enrich detail information through multi-frame spatial alignment and time series information complementation, and may obtain the final segmentation probability map in which the continuity of the image segmentation result is improved. Then, the image segmentation framework may extract high-dimensional semantic features by fusing the final segmentation probability map through the second image segmentation model, and may improve the accuracy of image segmentation, based on the extracted high-dimensional semantic features. The accuracy of such improved image segmentation may provide more accurate information for subsequent decision making in autonomous driving, thereby improving reliability of decision making, among other applications.

In addition, the second image segmentation model included in the image segmentation framework of the present disclosure may not only be compatible with image segmentation models used in various application fields but also may obtain an effect of improving the accuracy of the image segmentation in all application fields, thereby providing versatility of the corresponding framework.

Finally, model computation and inference time may be significantly reduced, compared to existing semantic segmentation models, thereby significantly reducing artificial labeling cost required for labeling a dataset.

The examples described herein may be implemented by using a hardware component, a software component, and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor, or any other device capable of responding to and executing instructions in a defined manner. The processing device may run an operating system (OS) and one or more applications that run on the OS. The processing device also may access, store, manipulate, process, and generate data in response to execution of the applications. For purpose of simplicity, the description of a processing device is singular; however, one of ordinary skill in the art will appreciate that a processing device may include a plurality of processing elements and a plurality of types of processing elements. For example, the processing device may include a plurality of processors, or a single processor and a single controller. In addition, different processing configurations are possible, such as parallel processors.

The applications (or the like) may include a computer program, a piece of code, an instruction, or some combination thereof, to independently or collectively instruct or configure the processing device to operate as desired. Software and data may be stored in any type of machine, component, physical or virtual equipment, or computer storage medium or device capable of providing instructions or data to or being interpreted by the processing device. The software may also be distributed over network-coupled computer systems so that the software is stored and executed in a distributed fashion. The software and data may be stored in a non-transitory computer-readable recording medium.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) discs and digital video discs (DVDs); magneto-optical media such as optical discs; and hardware devices that are specifically configured to store and perform program instructions, such as read-only memory (ROM), random access memory (RAM), flash memory, and the like (but not signals per se). Examples of program instructions include both machine code, such as one produced by a compiler, and files containing higher-level code that may be executed by the computer using an interpreter.

The above-described hardware devices may be configured to act as one or more software modules in order to perform the operations of the above-described examples, or vice versa.

The computing apparatuses, the vehicles, the electronic devices, the processors, the memories, the image sensors, the vehicle/operation function hardware, the displays, the information output system and hardware, the storage devices, and other apparatuses, devices, units, modules, and components described herein with respect to FIGS. 1-6 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-6 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An electronic device comprising:
one or more processors; and
a memory storing instructions configured to cause the one or more processors to perform a process comprising:
inputting a multi-frame image comprising frames to a first image segmentation model that generates preliminary segmentation probability maps based on the multi-frame image;
obtaining final segmentation probability maps by aligning the preliminary segmentation probability maps into a same space according to pose deltas of the frames, each pose delta comprising a position change and an angle change; and
obtaining a final image segmentation result by inputting the obtained final segmentation probability maps to a second image segmentation model.

2. The electronic device of claim 1, wherein one of the frames is a reference frame and the other frames are non-reference frames, and where the process further comprises:
determining the pose deltas relative to a pose of the reference frame;
aligning the preliminary segmentation probability maps of the respective non-reference frames into a same space as the preliminary segmentation probability map of the reference frame, based on the determined pose deltas;
setting pixel values for an empty space in the preliminary segmentation probability maps of the non-reference frames, the empty space caused by the aligning of the preliminary segmentation probability maps and lacking pixel values derived from the first image segmentation model; and
obtaining the final segmentation probability maps by connecting the preliminary segmentation probability maps having the set pixel values.

3. The electronic device of claim 2, wherein
the determining of the pose deltas comprises:
obtaining positions and angles of a same object included in each of the reference frame and the non-reference frames; and
determining the pose deltas of the non-reference frames by comparing the position and angle of the object in the reference frame with the positions and angles of the object in the non-reference frames.

4. The electronic device of claim 2, wherein
the setting of the pixel values for the empty space comprises, for a pixel in the empty space, in response to a number of valid pixels surrounding the pixel being greater than a preset number, determining a pixel value of the pixel based on pixel values of the valid pixels.

5. The electronic device of claim 2, wherein
the setting of the pixels in the empty space comprises, for a pixel in the empty space, in response a number of valid pixels surrounding the pixel being less than a preset number, determining a pixel value of the pixel based on a pixel value of a valid pixel, of the reference frame, that spatially corresponds to the pixel.

6. The electronic device of claim 5, wherein
the setting of the pixel value for the empty space comprises determining the pixel value of the omitted pixel by performing a matrix operation using a transformation matrix on the pixel value of the valid pixel of the reference frame.

7. The electronic device of claim 1, wherein
the obtaining of the final image segmentation result comprises:
extracting a semantic feature by fusing the final segmentation probability maps; and
obtaining the final image segmentation result by decoding the extracted semantic feature and determining a final category for each pixel of the final segmentation probability maps.

8. The electronic device of claim 1, wherein
the multi-frame image is generated from frames selected at set intervals from among frames collected over a predetermined period of time.

9. A method of operating an electronic device, the method comprising:
inputting a multi-frame image to a first image segmentation model that infers therefrom preliminary segmentation probability maps of the respective frames included in the multi-frame image;
forming the preliminary segmentation probability maps into respective final segmentation probability maps by aligning the preliminary segmentation probability maps into a same three-dimensional space according to differences in poses of the respective frames, each pose comprising an angle and position of its corresponding frame; and
obtaining a final image segmentation result for the multi-frame image based on inputting the obtained final segmentation probability maps to a second image segmentation model.

10. The method of claim 9, wherein
the obtaining of the final segmentation probability map comprises:
determining displacement and rotation differences between a reference frame, among the frames, and the other of the frames, which are non-reference frames;
aligning the preliminary segmentation probability maps of the non-reference frames into a space of the preliminary segmentation probability map of the reference frame, based on the determined displacements and rotations; and
before obtaining the final segmentation probability map, setting a pixel value for an empty space in a preliminary segmentation probability map of a non-reference frame, the empty space formed by the aligning of the preliminary segmentation probability map of the non-reference frame into the space of the preliminary segmentation probability map of the reference frame.

11. The method of claim 10, wherein
the determining of the displacements and the rotations comprises:
obtaining positions and angles of an object included in each of the reference frame and the non-reference frames; and
determining the displacements and the rotations based on the obtained positions and the obtained rotation angles of the object.

12. The method of claim 10, wherein
the setting of the pixel value for the empty space comprises, for a pixel in the empty space that does not have a value derived from the first image segmentation model due to the aligning of the preliminary segmentation probability containing the empty space, based on a number of valid pixels neighboring the pixel being greater than a threshold, setting the pixel to a value that is based on the pixel values of the valid pixels.

13. The method of claim 10, wherein
the setting of the pixel value for the empty space comprises, for a pixel in the empty space that does not have a value derived from the first image segmentation model due to the aligning of the preliminary segmentation probability containing the empty space, based on a number of valid pixels neighboring the pixel being less than a threshold, setting the pixel to a value that is based on the pixel value of a pixel of the reference frame that spatially corresponds to the pixel in the empty space.

14. The method of claim 13, wherein
the setting of the pixel value for the empty space comprises determining the pixel value of the pixel of the empty space by performing a matrix operation using a transformation matrix on the pixel of the reference frame.

15. The method of claim 9, wherein
the obtaining of the final image segmentation result comprises:
extracting a semantic feature by fusing the final segmentation probability maps; and
obtaining the final image segmentation result by decoding the extracted semantic feature and determining a final category for each pixel of the final segmentation probability maps.

16. The method of claim 9, wherein
the multi-frame image is generated from the frames, which are selected at set intervals from among frames collected over a predetermined period of time.

17. A non-transitory computer-readable storage medium storing instructions that, when executed by a processor, cause the processor to perform the method of claim 9.

18. A method performed by a computing device, the method comprising:
capturing images from respective image sensors, and inputting the images to a first image segmentation model that infers birds-eye-view (BEV) image segmentation probability (ISP) maps of the respective images, the images including a reference image and non-reference images, the reference image corresponding to a reference BEV ISP map among the BEV ISP maps, the non-reference images respectively corresponding to non-reference BEV ISP maps among the BEV ISP maps, and the images having associated therewith different three-dimensional poses, respectively;
performing, according to the poses, rotational and translational transforms on the BEV ISP maps to put the BEV ISP maps in a same alignment with respect to each other, the performing creating regions in the BEV ISP maps that lack data derived from the first image segmentation model;
for first pixels in the regions that have a number of neighboring pixels in the same non-reference BEV ISP map above a threshold, setting the first pixels to values of their neighboring pixels in the same non-reference BEV ISP map, and for second pixels in the regions that do not have a number of neighboring pixels in the same non-reference BEV ISP map above the threshold, setting the second pixels to values of corresponding pixels the reference BEV ISP map; and
after the setting of the first and second pixels, generating a final BEV ISP map by inputting the BEV ISP maps to a second image segmentation model that infers there from the final BEV ISP map.
